(19) United States
(12) Patent Application Publication
(10) Pub. No.: US 2011/0180716 A1
(43) Pub. Date: Jul. 28, 2011

(54) RADIATION DETECTION ELEMENT

(75) Inventor: Yoshihiro OKADA, Ashigarakami-gun (JP)

(73) Assignee: FUJIFILM CORPORATION, Tokyo (JP)

(21) Appl. No.: 12/969,048

(22) Filed: Dec. 15, 2010

(30) Foreign Application Priority Data
Jan. 28, 2010 (JP) 2010-016826
Sep. 22, 2010 (JP) 2010-212739

(51) Int. Cl. G01T 1/24

(52) U.S. Cl. 250/370.08

(57) ABSTRACT

The present invention provides a radiation detection element including, a substrate that has a top surface, which has provided thereon, plural pixels, plural scan lines through which control signals flow for switching switching elements included in the plural pixels, and plural signal lines connected to the switching elements through lines that change to a non-conductive state by irradiation of a laser beam, through which electric signals according to charges generated in the plural pixels flow, in accordance with switching states of the switching elements, an intermediate insulation film provided on the lower side of sensor sections, and an intermediate insulation film provided on the upper side of the sensor sections, including portions that correspond to laser beam irradiation portions of the lines and are opened.

### CROSS-REFERENCE TO RELATED APPLICATION

This application claims priority under 35 USC 119 from Japanese Patent Application No. 2010-016826, filed on Jan. 28, 2010, and Japanese Patent Application No. 2010-212739, filed on Sep. 22, 2010 the disclosure of which is incorporated by reference herein.

### BACKGROUND OF THE PRESENT INVENTION

1. Field of the Invention

The present invention relates to a radiation detection element. In particular, the present invention relates to a radiation detection element that accumulates charges generated due to irradiation of radiation and that detects the charge amount as information that represents an image.

2. Description of the Related Art

Recently, radiographic imaging devices have been put into practice employing a radiographic detection element of a FPD (flat panel detector), or the like. Such radiographic detection element have an X-ray sensitive layer disposed on a TFT (Thin Film Transistor) active matrix substrate, and are able to directly convert X-ray information into digital data. Such FPDs have the merit that, in comparison to with previous imaging plates, images can be more immediately checked and video images can also be checked. Consequently the introduction of FPDs is proceeding rapidly.

Various types are proposed for such radiation detection element. There are, for example, direct-conversion-type radiation detection elements that convert radiation directly to charge in a semiconductor layer, and accumulate the charge. There are also indirect-conversion-type radiation detection elements that first convert radiation into light with a scintillator, such as CsI:Tl, GOS (Gd₂O₂S:Tb) or the like, then convert the converted light into charge in a semiconductor layer and accumulate the charge.

In the conventional art, a technology for deleting by evaporating a transistor by irradiating a laser beam onto the transistor and disconnecting a malfunctioning sensor cell from a signal line, is known (for example, refer to Japanese Patent No. 4311693).

In general, a technology for irradiating a laser beam onto a predetermined laser beam irradiation portion and preventing an electric signal according to charges generated in a sensor section from being supplied to a signal line, is known. The predetermined laser beam irradiation portion is a line that connects a source electrode or a drain electrode of a transistor of a malfunctioning pixel and the signal line. According to this technology, a laser beam is irradiated onto a predetermined laser beam irradiation portion of a line, that connects a gate electrode and a scan line, to prevent a control signal to be supplied with from the scan line to the gate electrode of the transistor. Accordingly, this technology may separate normal pixels from the malfunctioning pixels.

For example, in an array inspection of a TFT in the conventional art, as shown in FIGS. 10A and 10B, when a leak defect between the lines is detected, a detected pixel is separated by laser cutting. The leak defect between the lines is converted into a point defect. As the leak defect shown in FIG. 10A, for example, a leak between the lines due to a hillock of Al corresponding to a gate line material can be considered. In the conventional art, after repairing based on laser cutting (laser repairing), the array inspection is performed again. After it is confirmed that the leak defect between the lines is converted into the point defect, the following processes are executed.

Meanwhile, in a TFT array for indirect DR, for example, as shown in FIGS. 11 and 12, in order to prevent a leak defect of an end portion of a photodiode, a second intermediate insulation film is preferably disposed after the photodiode is formed. In The TFT array for the indirect DR, the photodiode is disposed on an upper layer of the TFT through a first intermediate insulation film (flattening film). Note that, FIG. 11 is a plan view showing a structure of each one pixel of the radiation detection element. Further, FIG. 12 is a cross-sectional view taken along the line A-A of FIG. 11.

By this structure, the leak defect of the end of the photodiode may be prevented and a manufacturing yield of a photodiode TFT array may be improved. However, when the laser repairing is performed, as shown in FIG. 13, the laser beam may be absorbed by the intermediate insulation films of the two layers, and the laser beam may not be transmitted to a wiring layer. Accordingly, case occur where the lines does not change to a non-conductive state by irradiation of the laser beam.

### SUMMARY OF THE PRESENT INVENTION

The present invention provides a radiation detection element that may easily change lines to a non-conductive state by irradiation of a laser beam.

A first aspect of the present invention is a radiation detection element including: a substrate that has a top surface, which has provided thereon, a plurality of pixels, disposed in a matrix, that include switching elements for reading out charges generated in sensor sections, a plurality of scan lines through which control signals flow for switching the switching elements, and a plurality of signal lines, connected to the switching elements through lines that changes to a non-conductive state by irradiation of a laser beam, wherein electric signals according to the charges generated in the plurality of pixels flow through the plurality of signal lines in accordance with switching states of the switching elements; a first flattening film provided on a lower side of the sensor sections; and a second flattening film, provided on an upper side of the sensor sections, wherein portions of the second flattening film that correspond to laser beam irradiation portions of the lines are opened, or a thickness of the portions of the second flattening film that correspond to the laser beam irradiation portions is made thinner than a thickness of portions other than the portions that correspond to the laser beam irradiation portions.

According to the radiation detection element of the first aspect of the present invention, the portions corresponding to the laser beam irradiation portions of the lines of the second flattening film are opened. On the other hand, according to the radiation detection element of the first aspect, a thickness of the portions of the second flattening film corresponding to the laser beam irradiation portions is made thinner than a thickness of the portions other than the portions corresponding to the laser beam irradiation portions. Accordingly, in the radiation detection element of the first aspect, absorption of the laser beam by the flattening film may be suppressed. Therefore, in the radiation detection element of the first aspect, the lines may be easily changed to a non-conductive state by the irradiation of the laser beam.

A second aspect of the present invention is a radiation detection element including: a substrate that has a top surface, which has provided thereon, a plurality of pixels, disposed in a matrix, that include switching elements for reading out charges generated in sensor sections, a plurality of scan lines through which control signals flow for switching the switching elements, and a plurality of signal lines, connected to the switching elements through lines that change to a non-conductive state by irradiation of a laser beam, wherein electric signals according to the charges generated in the plurality of pixels flow through the plurality of signal lines in accordance with switching states of the switching elements; a first flattening film, provided on a lower side of the sensor sections, wherein a thickness of portions of the first flattening film that correspond to laser beam irradiation portions of the lines is made thinner than a thickness of portions other than the portions that correspond to the laser beam irradiation portions; and a second flattening film, provided on an upper side of the sensor sections.

According to the radiation detection element of the second aspect of the present invention, a thickness of the first flattening film at the portions the corresponding to the laser beam irradiation portions of the lines is made thinner than a thickness of the first flattening film at the portions other than the portions corresponding on the laser beam irradiation portions. For this reason, in the radiation detection element of the second aspect, absorption of the laser beam by the flattening film may be suppressed. Accordingly, in the radiation detection element of the second aspect, the lines may be easily changed to a non-conductive state by irradiation of the laser beam.

A third aspect of the present invention is a radiation detection element including: a substrate that has a top surface, which has provided thereon, a plurality of pixels, provided in a matrix, that include switching elements for reading out charges generated in sensor sections, a plurality of scan lines, connected to the switching elements through lines that change to a non-conductive state by irradiation of a laser beam, through which control signals flow for switching the switching elements, and a plurality of signal lines, through which electric signals according to the charges generated in the plurality of pixels flow, in accordance with switching states of the switching elements; a first flattening film, provided on a lower side of the sensor sections; and a second flattening film, provided on an upper side of the sensor sections, wherein portions of the second flattening film that correspond to laser beam irradiation portions of the lines are opened, or a thickness of the portions of the second flattening film that correspond to the laser beam irradiation portions is made thinner than a thickness of portions other than the portions that correspond to the laser beam irradiation portions.

According to the radiation detection element of the third aspect of the present invention, the portions corresponding to the laser beam irradiation portions of the lines of the second flattening film are opened. On the other hand, according to the radiation detection element of the third aspect, a thickness of the portions corresponding to the laser beam irradiation portions is made thinner than a thickness of the portions other than the portions corresponding to the laser beam irradiation portions. Therefore, in the radiation detection element of the third aspect, absorption of the laser beam by the flattening film may be suppressed. As a result, in the radiation detection element of the third aspect, the lines may be easily caused to enter in a non-conductive state by irradiation of the laser beam.

A fourth aspect of the present invention is a radiation detection element including: a substrate that has a top surface, which has provided thereon, a plurality of pixels, disposed in a matrix, that include switching elements for reading out charges generated in sensor sections, a plurality of scan lines, connected to the switching elements through lines that change to a non-conductive state by irradiation of a laser beam, through which control signals flow for switching the switching elements, and a plurality of signal lines through which electric signals according to the charges generated in the plurality of pixels flow, in accordance with switching states of the switching elements; a first flattening film, provided on a lower side of the sensor sections, wherein a thickness of portions of the first flattening film that correspond to laser beam irradiation portions of the lines is made thinner than a thickness of portions other than the portions that correspond to the laser beam irradiation portions; and a second flattening film, provided on a side opposite to a side of the first flattening film where the substrate is positioned.

According to the radiation detection element of the fourth aspect of the present invention, a thickness of the first flattening film at the portions corresponding to the laser beam irradiation portions of the lines is made thinner than the thickness of the first flattening film at the portions other than the portions corresponding to the laser beam irradiation portions. Therefore, in the radiation detection element of the fourth aspect, absorption of the laser beam by the flattening film may be suppressed. Accordingly, in the radiation detection element of the fourth aspect, the lines may be easily changed to a non-conductive state by irradiation of the laser beam.

A fifth aspect of the present invention, in the second and fourth aspects, the portions of the second flattening film that correspond to the laser beam irradiation portions of the lines may be opened, or a thickness of the portions of the second flattening film that correspond to the laser beam irradiation portions may be made thinner than a thickness of portions other than the portions that correspond to the laser beam irradiation portions.

A sixth aspect of the present invention, in the abode aspects, the sensor sections may be formed to cover a pixel region where the pixels are disposed, while exposing the portions that correspond to the laser beam irradiation portions.

A seventh aspect of the present invention, in the sixth aspect, the portions of the sensor sections that correspond to the laser beam irradiation portions may be formed in a concave shape.

According to the aspects of the present invention, the lines may be easily changed to a non-conductive state by irradiation of the laser beam.

### BRIEF DESCRIPTION OF THE DRAWINGS

Exemplary embodiments of the present invention will be described in detail based on the following figures, wherein:

FIG. 1 is a diagram showing the entire configuration of a radiation imaging device according to an exemplary embodiment present invention;

FIG. 2 is a plan view showing the configuration of a radiation detection element according to the exemplary embodiment;

FIG. 3 is a cross-sectional view of the radiation detection element according to the exemplary embodiment;

FIG. 4 is a cross-sectional view of the case where a leak defect is generated in the radiation detection element according to the exemplary embodiment;

FIG. 5 is a diagram illustrating a result obtained by irradiating a laser beam onto the radiation detection element according to the exemplary embodiment;

FIG. 6 is a diagram showing a modification of the radiation detection element according to the exemplary embodiment;

FIG. 7 is a diagram showing a modification of the radiation detection element according to the exemplary embodiment;

FIG. 8 is a diagram showing a modification of the radiation detection element according to the exemplary embodiment;

FIG. 9 is a diagram showing a modification of the radiation detection element according to the exemplary embodiment;

FIG. 10A and FIG. 10B are diagrams illustrating the conventional art;

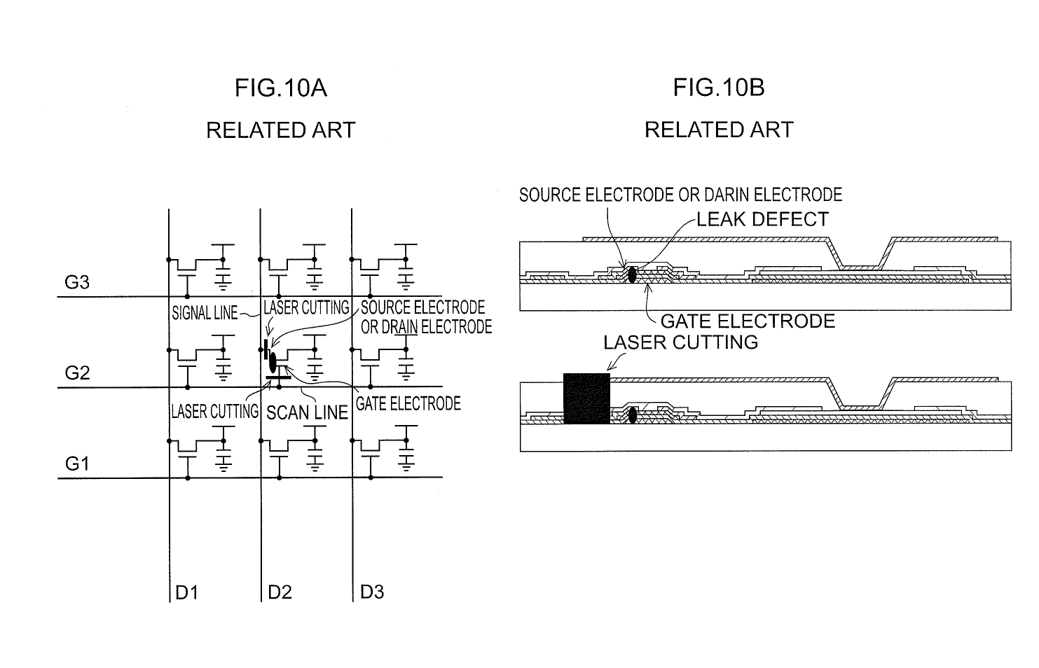

FIG. 11 is a diagram illustrating the conventional art;

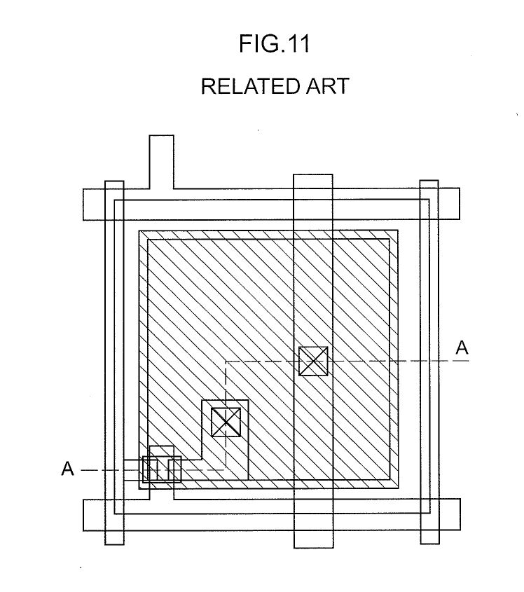

FIG. 12 is a diagram illustrating the conventional art;

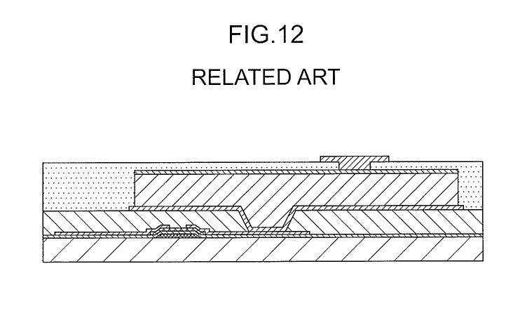

FIG. 13 is a diagram illustrating the conventional art;

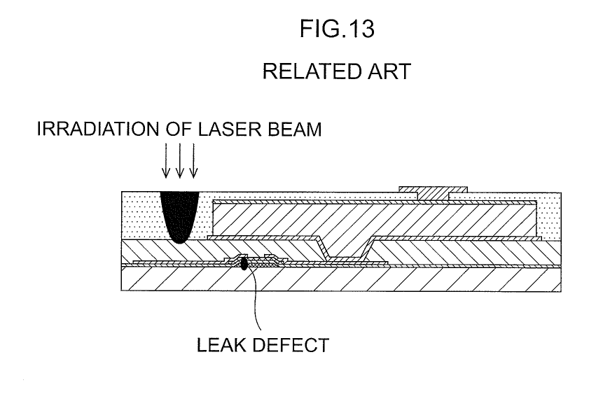

FIG. 14 is a plan view showing the configuration of a modification of a radiation detection element according to an alternative exemplary embodiment of the present invention; and

FIG. 15 is a cross-sectional view of a modification of the radiation detection element according to an alternative exemplary embodiment of the present invention.

### DETAILED DESCRIPTION OF THE PRESENT INVENTION

Hereinafter, exemplary embodiments of the present invention will be described with reference to the drawings.

In the present exemplary embodiment, a case where the present invention is applied to a radiation detection element 10 of an indirect-conversion-type will be described. In the indirect-conversion-type, radiation having the first wavelength is converted into radiation having the second wavelength, and the converted radiation having the second wavelength is converted into charges. In the following description, an example of a case where the radiation having the first wavelength is simply called “radiation (for example, X-rays)” and the radiation having the second wavelength different from the first wavelength is “light” will be described. However, the radiation having the first wavelength and the radiation having the second wavelength are not limited thereto.

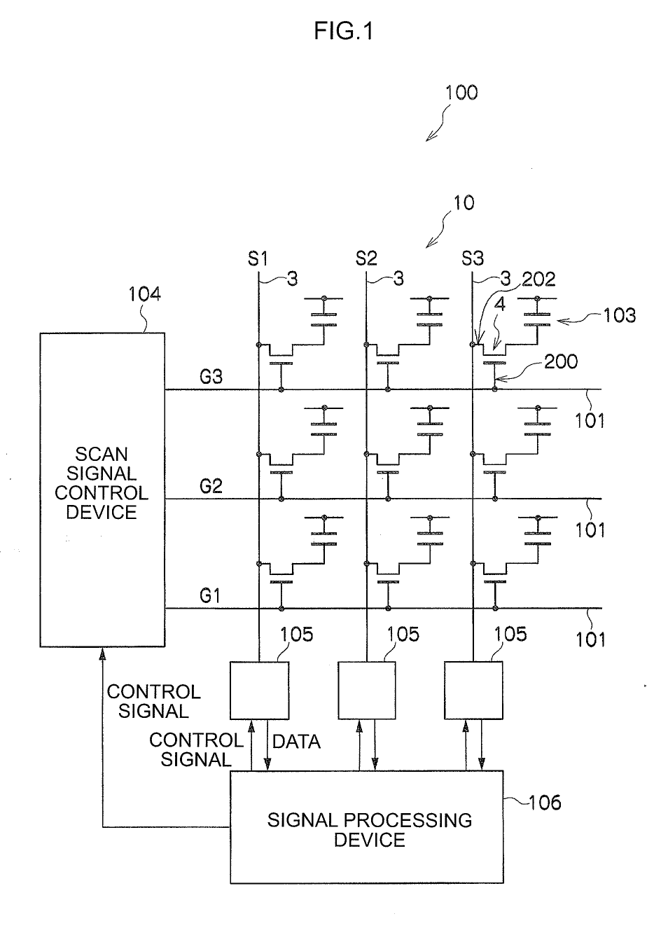

FIG. 1 shows the entire configuration of a radiation imaging device (radiation image detection device) 100 using a radiation detection device (radiation detection element) 10 according to a first exemplary embodiment. A scintillator that converts radiation (for example, X-rays) into light and emits the light is not shown in the drawings.

The radiation imaging device 100 according to the present exemplary embodiment includes the radiation detection element 10 of the indirect-conversion-type.

In the radiation detection element 10, plural pixels each of which is configured to include a sensor section 103 and a TFT switch 4, and are arranged two-dimensionally. The sensor section 103 includes an upper electrode, a semiconductor layer, and a lower electrode, and receives the light obtained by converting the irradiated radiation by the scintillator and accumulates the charges. The TFT switch 4 reads out the charges that are accumulated in the sensor section 103.

In the radiation detection element 10, plural scan lines 101 and plural signal lines 3 are provided to intersect with each other. Each of the plural scan lines 101 turns ON/OFF the TFT switches 4. Each of the plural signal lines 3 reads out the charges that are accumulated in the sensor section 103. The plural scan lines 101 and the TFT switches 4 (specifically, gate electrodes of the TFT switches 4) are connected to each other through lines 200. The plural signal lines 3 and the TFT switches 4 (specifically, source electrodes and drain electrodes of the TFT switches) are connected to each other through lines 202.

When any TFT switch 4 connected to each signal line 3 is turned ON, an electric signal according to the charge amount accumulated in the sensor section 103 is output to each signal line 3. To each signal line 3, a signal detecting circuit 105 that detects the electric signal output to each signal line 3 is connected. To each scan line 101, a scan signal control device 104 that outputs a control signal to turn ON/OFF each TFT switch 4 to each scan line 101 is connected.

The signal detecting circuit 105 includes an amplifying circuit that amplifies the input electric signal, for each signal line 3. In the signal detecting circuit 105, the electric signal that is input from each signal line 3 is amplified by the amplifying circuit, and is detected. Accordingly, the signal detecting circuit 105 detects the charge amount accumulated in each sensor section 103 as information of each of the pixels forming an image.

A signal processing device 106 is connected to the signal detecting circuit 105 and the scan signal control device 104. The signal processing device 106 executes predetermined processing to the electric signal detected in the signal detecting circuit 105. In addition, the signal processing device 106 outputs a control signal indicating signal detection timing to the signal detecting circuit 105, and outputs a control signal indicating output timing of a scan signal to the scan signal control device 104.

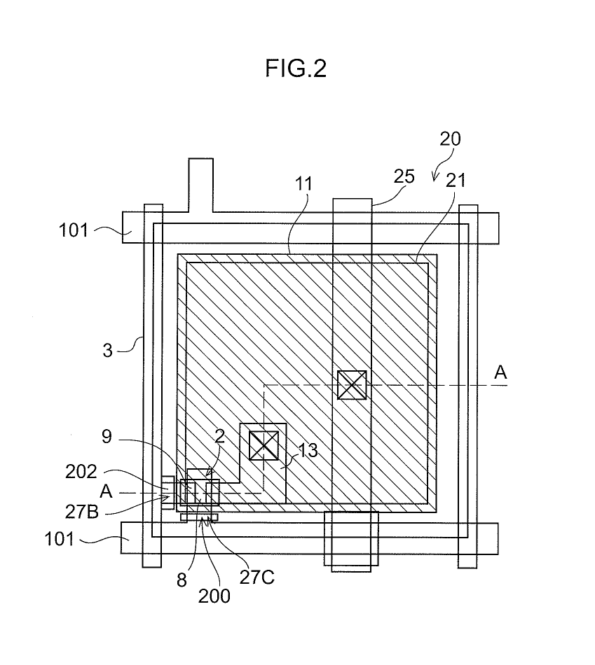

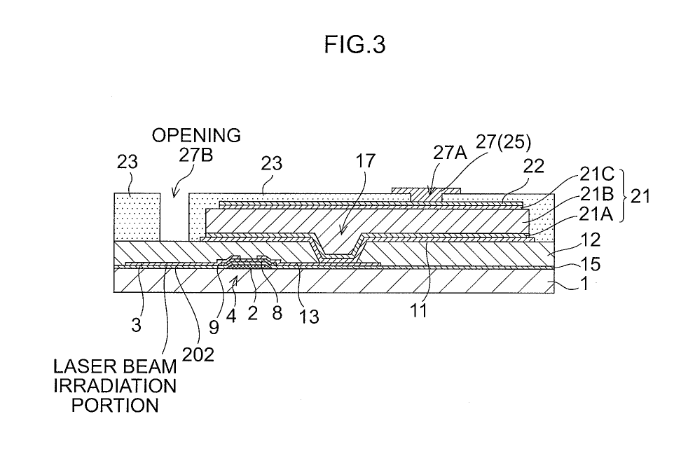

Next, the radiation detection element 10 according to the present exemplary embodiment will be described in detail with reference to FIG. 2 and FIG. 3. FIG. 2 is a plan view showing a structure of each pixel of the radiation detection element 10 according to the present exemplary embodiment. FIG. 3 is a cross-sectional view taken along the line A-A of FIG. 2.

As shown in FIG. 2 and FIG. 3, in the radiation detection element according to the present exemplary embodiment, the scan lines 101 and the gate electrodes 2 are formed on an insulating substrate 1 made of alkali-free glass or the like. The scan lines 101 and the gate electrodes 2 are connected to each other (refer to FIG. 2). The scan line 101 and the gate electrode 2 are connected via the line 200. The line 200 changes to a non-conductive state by evaporation through irradiation of a laser beam. Namely, the scan line 101 and the gate electrode 2 may be electrically disconnected by irradiating the laser beam onto the line 200. The wiring layer in which this scan lines 101 and gate electrodes 2 are formed (this wiring layer is referred to below as “the first signal wiring layer”) is formed from Al and/or Cu, or a layered film mainly composed of Al and/or Cu. However, the material of the first signal wiring layer is not limited thereto.

On the scan lines 101, the gate electrodes 2, and the line 200, an insulating film 15 is formed on one surface to cover the scan lines 101, the gate electrodes 2, and the line 200. The locations of the insulation film 15 positioned over the gate electrodes 2 are employed as a gate insulation film in the TFT switches 4. The insulation film 15 is, for example, formed from SiNₓ or the like by, for example, Chemical Vapor Deposition (CVD) film forming.

An island shape of a semiconductor active layer 8 is formed on each of the gate electrodes 2 above the insulation film 15. The semiconductor active layer 8 is a channel portion of the TFT switch 4 and is, for example, formed from an amorphous silicon film.

A source electrode 9 and a drain electrode 13 are formed in a layer above. The wiring layer in which the source electrode 9 and the drain electrode 13 are formed also has the signal lines 3 and lines 202 formed therein. The source electrode 9 is connected to the signal lines 3 via the lines 202. The line 202 changes to a non-conductive state by evaporation through irradiation of a laser beam. Namely, the signal line 3 and the source electrode 9 may be electrically disconnected by irradiating the laser beam onto the line 202. The wiring layer in which the source electrode 9, the drain electrode 13, the lines 202 and the signal lines 3 are formed (this wiring layer is referred to below as “the second signal wiring layer”) is formed from Al and/or Cu, or a layered film mainly composed of Al and/or Cu. However, the material of the second signal wiring layer is not limited thereto. An impurity doped semiconductor layer (not shown) of, for example, impurity doped amorphous silicon or the like, is formed between the semiconductor active layer 8 and both the source electrode 9 and the drain electrode 13. The TFT switch 4 employed for switching is configured as described above. The source electrodes 9 and the drain electrodes 13 of the of the TFT switches 4 are of opposite polarity to that of the charge collected and accumulated with the lower electrode 11, described below. When the TFT switch 4 is of opposite polarity, the signal line 3 and the drain electrode 13 may be electrically disconnected by irradiating the laser beam onto the line 202.

A coating type intermediate insulation film (flattening film) 12 is formed over substantially the whole surface (substantially the entire region) of regions provided with the pixels 20 above the substrate 1 so as to cover the second signal wiring layer. As shown in FIG. 3, the intermediate insulation film 12 is provided on the top surface of the substrate 1. This intermediate insulation film 12 is formed from a photosensitive organic material of low permittivity (dielectric constant ∈ᵣ=2 to 4) (for example, a material such as a positive-working photosensitive acrylic resin: a base polymer of a copolymer of methacrylic acid and glycidyl methacrylate, into which a naphthoquinone-diazido positive-working photosensitive agent has been mixed). The film thickness of the intermediate insulation film 12 is 1 to 4 μm. Further, as the intermediate insulation film 12, an intermediate insulation film that uses an inorganic material as a principal component and has the thickness of 1 μm or more (for example, 1 to 4 μm) may also be used. Note that the intermediate insulation film 12 corresponds to a first flattening film in the present invention.

In the radiation detection element 10 according to the present exemplary embodiment, capacitance between the metal layers disposed above and below the intermediate insulation film 12 can be suppressed to a low value by provision of the intermediate insulation film 12. Furthermore, generally such materials also have the functionality of a flattening layer, and exhibit the effect of flattening the steps in the layer below. In the radiation detection element 10 according to the present exemplary embodiment, a contact hole 17 is formed in the intermediate insulation film 12 at positions facing the drain electrode 13.

The lower electrode 11 of each of the sensor sections 103 is formed on the intermediate insulation film 12 to fill the contact hole 17 and cover the pixel region. The lower electrode 11 contacts the drain electrode 13 of the TFT switch 4. As long as the lower electrode 11 is electrically conductive, there are no particular limitations to the material of the lower electrode 11 for cases in which the thickness of a semiconductor layer 21, described below, is about 1 μm. Hence the lower electrode 11 may be formed with an electrically conductive metal such as, for example, an Al based material, ITO or the like.

However, in cases in which the film thickness of the semiconductor layer 21 is thin (about 0.2 μm to 0.5 μm), light may not be sufficiently absorbed by the semiconductor layer 21, and measures need to be taken to prevent an increase in leak current flow due to light illumination onto the TFT switch 4. Consequently, in such cases the lower electrode 11 is preferably an alloy or layered film with a metal having light-blocking ability as a main component.

The semiconductor layer 21 is formed on the lower electrode 11 and functions as a photodiode. In the present exemplary embodiment, a photodiode of PIN structure is employed, in which an n⁺ layer, an i layer and a p⁺ layer (n⁺ amorphous silicon, amorphous silicon, p⁺ amorphous silicon) are layered on each other as the semiconductor layer 21. Consequently, in the semiconductor layer 21 of the present exemplary embodiment, an n⁺ layer 21A, an i layer 21B and a p⁺ layer 21C are formed, layered in this sequence from the bottom layer. The i layer 21B generates charge (pairs of free electrons and free holes) due to illumination of light. The n⁺ layer 21A and the p⁺ layer 21C function as contact layers, and respectively electrically connect the lower electrode 11 and the upper electrode 22 with the i layer 21B.

In the present exemplary embodiment, the lower electrode 11 is formed with larger surface area than the semiconductor layer 21. Further, the light illumination side of the TFT switch 4 is covered by the semiconductor layer 21. Accordingly, in the present exemplary embodiment, the proportion of surface area within the pixel regions that can receive light (called the fill factor) is made larger, and light can be suppressed from being incident on the TFT switches 4.

Individual upper electrodes 22 are formed on each of the semiconductor layers 21. The upper electrodes 22 are, for example, formed using a material having high light transmissive, such as ITO, Indium Zinc Oxide (IZO) or the like. In the radiation detection element 10 according to the present exemplary embodiment, each of the sensor section 103 is configured including the upper electrode 22, the semiconductor layer 21, and the lower electrode 11.

A coating type intermediate insulation film (flattening film) 23 is formed on the intermediate insulation film 12, the semiconductor layer 21, and the upper electrode 22 to cover the semiconductor layer 21. The intermediate insulation film 23 has an opening 27A at a portion corresponding to the upper electrode 22, an opening 27B at a portion (position) corresponding to a laser beam irradiation portion on the line 202, and an opening 27C at a portion corresponding to the laser beam irradiation portion on the line 200 (refer to FIG. 2). The intermediate insulation film 23 is formed of a photosensitive organic material with low dielectric constant (dielectric constant of ∈ᵣ=2 to 4) (for example, positive photosensitive acrylic resin: material obtained by mixing a base polymer made of a copolymer of methacrylic acid and glycidyl methacrylate with a naphthoquinonediazide positive photosensitive agent). The thickness of the intermediate insulation film 23 is 1 μm or more (for example, 1 μm to 4 μm). As the intermediate insulation film 23, an intermediate insulation film that includes an inorganic material as a principal component and has the thickness of 1 μm or more (for example, 1 μm to 4 μm) can be used. The intermediate insulation film 23 corresponds to a second flattening film in the present invention. Generally such materials also have the functionality of a flattening layer, and exhibit the effect of flattening the steps in the layer below.

Namely, the intermediate insulation film 23 according to the present exemplary embodiment is provided on a side opposite to a side of the intermediate insulation film 12 where the substrate 1 is positioned. In the intermediate insulation film 23 according to the present exemplary embodiment, portions corresponding to the laser beam irradiation portions in the lines 200 and 202 are opened. Namely, the laser beam irradiation portions indicate the positions of the laser beam to be irradiated to the lines 200 and 202. For example, the laser beam is irradiated onto the lines 200 and 202, with respect to the pixel 20 where a leak defect is detected. Accordingly, the lines 200 and 202 change to a non-conductive state. Thereby, the pixel 20 where the leak defect is detected becomes a pixel of a point defect. Therefore, according to the radiation detection element 10 according to the present exemplary embodiment, the portions corresponding to the laser beam irradiation portions of the lines 200 and 202 are opened in the intermediate insulation film 23. For this reason, in the present exemplary embodiment, absorption of the laser beam by the flattening film may be suppressed. Therefore, in the present exemplary embodiment, the lines may be easily changed to a non-conductive state by the irradiation of the laser beam.

Common electrode lines 25 are formed by a layered film of Al and/or Cu, or an alloy mainly composed of Al and/or Cu formed on the intermediate insulation film 23. Contact pads 27 are formed to the common electrode line 25 in the vicinity of the opening 27A. The common electrode lines 25 are electrically connected to the upper electrodes 22 by the contact pads 27 via the openings 27A in the intermediate insulation films 23.

In the radiation detection element 10 configured as described above, as required, a protection layer may be formed from an insulating material with low light absorption characteristics, and a scintillator, configured, for example, from GOS or the like, is attached using an adhesive resin with low light absorption characteristics formed on the surface of the protection layer.

Next, an operation of the radiation image detection device 100 that has the above structure will be described.

If the X-rays are irradiated from the upper side of FIG. 3, the irradiated X-rays (radiation having the first wavelength) are absorbed by the scintillator and are converted into visible light (radiation having the second wavelength). The X-rays may be irradiated from the lower side of FIG. 3. Even in this case, the irradiated X-rays are absorbed by the scintillator and are converted into visible light. The amount of light that is generated from the scintillator is 0.5 μW/cm² to 2 μW/cm² in the case where common X-ray imaging for medical diagnosis is used. The generated light passes through the layer of the adhesive resin 28 and illuminates the semiconductor layer 21 of the sensor section 103 disposed in an array.

In the radiation detection element 10, the semiconductor layer 21 is separated into each pixel unit. To the semiconductor layer 21, a predetermined bias voltage is applied from the upper electrode 22 through the common electrode line 25. When the light illuminates the semiconductor layer 21, the semiconductor layer 21 generates charges therein. For example, when the semiconductor layer 21 has the PIN structure where the layers are layered in order of n⁺-i-p⁺ (n⁺ amorphous silicon, amorphous silicon, and p⁺ amorphous silicon) from the lower layer, a negative bias voltage is applied to the upper electrode 22. When the thickness of the i layer is about 1 μm, the applied bias voltage is about −5 V to −10 V. In the above state, when the light is not illuminated, only a current of several to several ten pA/mm² or less flows through the semiconductor layer 21. Meanwhile, in the above state, when the light is illuminated (100 μW/cm²), a light current of about 0.3 μW/mm² is generated in the semiconductor layer 21. The generated charges are collected by the lower electrode 11. The lower electrode 11 is connected to the drain electrode 13 of the TFT switch 4. The source electrode 9 of the TFT switch 4 is connected to the signal line 3. When the image is detected, a negative bias is applied to the gate electrode 2 of the TFT switch 4 and the TFT switch 4 is maintained in an OFF state. As a result, the collected charges are accumulated in the lower electrode 11.

When an image is read out, an ON signal (+10 V to 20 V) is sequentially applied to the gate electrode 2 of the TFT switch 4 through the scan line 101. Thereby, the TFT switches 4 are sequentially turned ON. As a result, an electric signal according to the charge amount accumulated in the lower electrode 11 is output to the signal line 3. The signal detecting circuit 105 detects the charge amount accumulated in each sensor section 103 as information of each of the pixels forming an image on the basis of the electric signal. Thereby, the radiation detection element 10 may obtain image information that represents the irradiated X-rays.

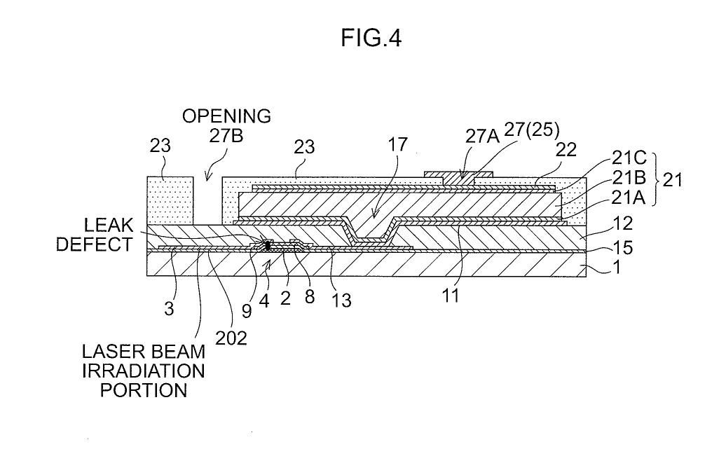

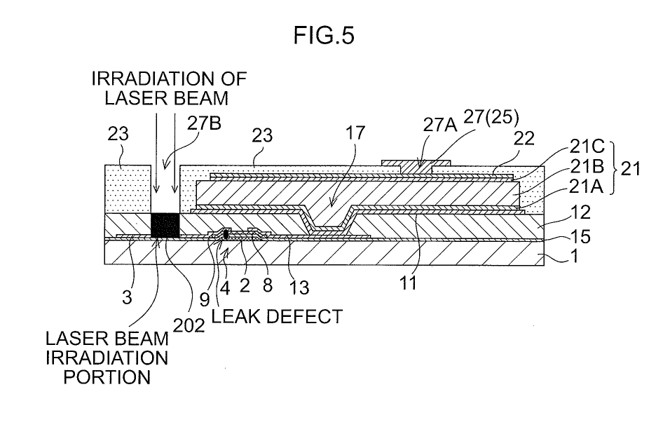

As the inspection result of the radiation detection element 10, as shown in FIG. 4, when the leak defect is detected, as shown in FIG. 5, the laser beam is irradiated onto the laser beam irradiation portion of the pixel 20 where the leak defect is detected, and the lines 200 and 202 are caused to change to a non-conductive state. At this time, in the radiation detection element 10 according to the present exemplary embodiment, the portions corresponding to the laser beam irradiation portions on the lines 200 and 202 are opened in the intermediate insulation film 23. Accordingly, in the present exemplary embodiment, absorption of the laser beam based on the flattening film may be suppressed. Therefore, in the present exemplary embodiment, the lines may be easily changed to a non-conductive state by the irradiation of the laser beam.

According to the present exemplary embodiment, absorption of the laser beam based on the flattening film may be suppressed, as described above. As a result, in the present exemplary embodiment, the lines may be caused to change to a non-conductive state by irradiation of the laser beam.

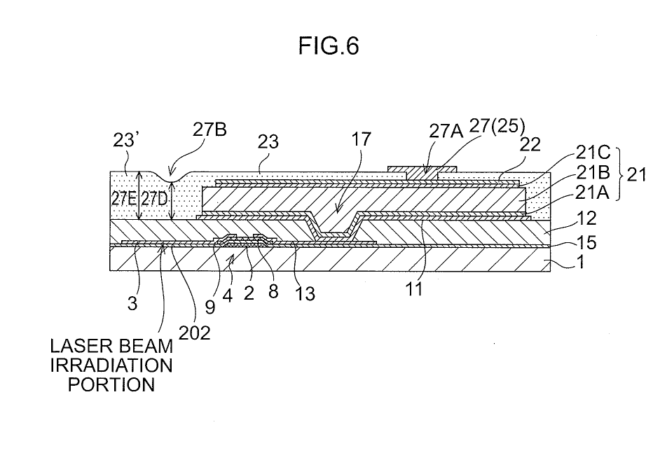

The case where the openings are provided in the corresponding portions on the laser beam irradiation portions and the intermediate insulation film 23 having the opened portions is used is described above. However, in a modification of the present exemplary embodiment, as shown in FIG. 6, an intermediate insulation film (flattening film) 23′ where a thickness 27D of the intermediate insulation film 23 at portions corresponding to the laser beam irradiation portions may be made thinner than a thickness 27E of the intermediate insulation film at portions other than the portions corresponding to the laser beam irradiation portions. By this configuration, in the modification of the present exemplary embodiment, absorption of the laser beam by the flattening film may be suppressed. Accordingly, the lines may be easily changed to a non-conductive state by the irradiation of the laser beam.

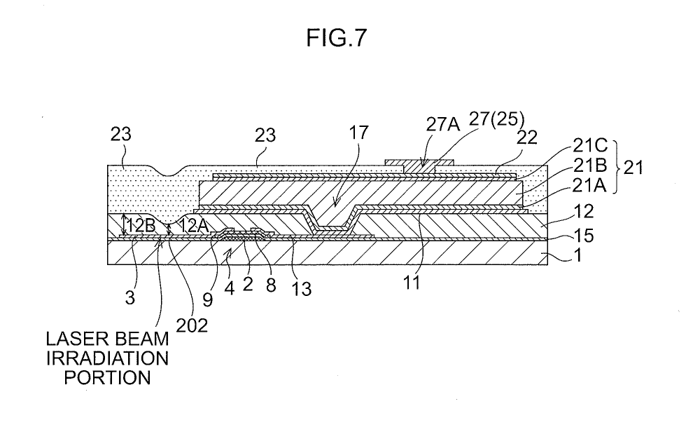

As shown in FIG. 7, in a modification of the present exemplary embodiment, a thickness 12A of the intermediate insulation film 12 (corresponding to the first flattening film) at portions corresponding to the laser beam irradiation portions may be made thinner than a thickness 12B of the intermediate insulation film at portions other than the portions corresponding to the laser beam irradiation portions. By this configuration, in the modification of the present exemplary embodiment, absorption of the laser beam by the flattening film may be suppressed. Accordingly, in the modification of the present exemplary embodiment, the lines may be easily changed to a non-conductive state by the irradiation of the laser beam.

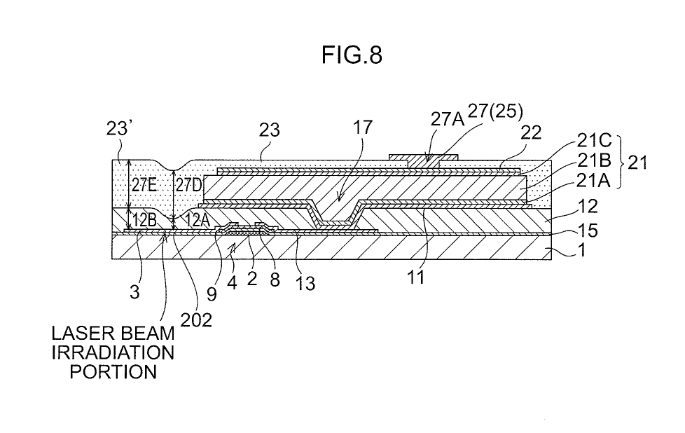

As shown in FIG. 8, in a modification of the present exemplary embodiment, an intermediate insulation film 23′ where a thickness 27D of the intermediate insulation film at portions corresponding to the laser beam irradiation portions may be made thinner than a thickness 27E of the intermediate insulation film at portions other than the portions corresponding to the laser beam irradiation portions. In addition, in the modification of the present exemplary embodiment, the thickness 12A of the intermediate insulation film 12 (corresponding to the first flattening film) at portions corresponding to the laser beam irradiation portions may be made thinner than a thickness 12B of the intermediate insulation film at portions other than the portions corresponding to the laser beam irradiation portions may be used. By this configuration, in the modification of the present exemplary embodiment, absorption of the laser beam by the flattening film may be suppressed. Accordingly, in the modification of the present exemplary embodiment, the lines may be easily changed to a non-conductive state by the irradiation of the laser beam.

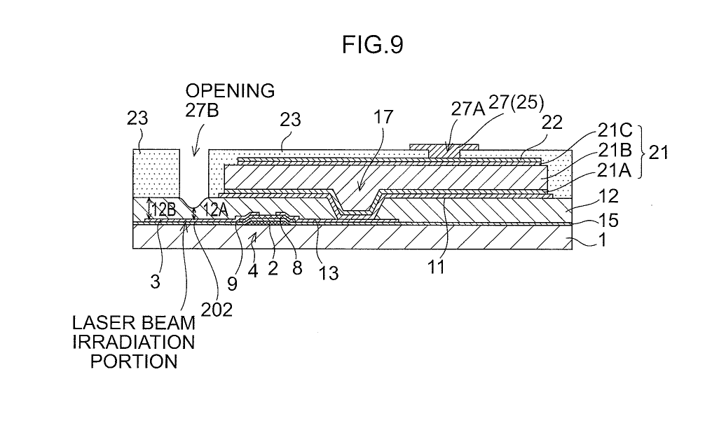

As shown in FIG. 9, in a modification of the present exemplary embodiment, the intermediate insulation film 23 where portions corresponding to the laser beam irradiation portions may be opened. In addition, in the modification of the present exemplary embodiment, a thickness 12A of the intermediate insulation film 12 (corresponding to the first flattening film) at portions corresponding to the laser beam irradiation portions may be made thinner than a thickness 12B of the intermediate insulation film at portions other than the portions corresponding to the laser beam irradiation portions. By this configuration, in the modification of the present exemplary embodiment, absorption of the laser beam by the flattening film may be suppressed. As a result, in the modification of the present exemplary embodiment, the lines may be easily changed to a non-conductive state by the irradiation of the laser beam.

In the above exemplary embodiment, a case where the laser beam is irradiated onto both the laser beam irradiation portion of the line 200 and the laser beam irradiation portion of the line 202 when the leak defect is detected, was described. However, the laser beam may be irradiated onto only the laser beam irradiation portion of the line 200 or the laser beam irradiation portion of the line 202. At this time, the thickness of the flattening film (intermediate insulation film 12 or intermediate insulation film 23) on the laser beam irradiation portion at the side where the laser beam is irradiated may be thin, as described above.

In the radiation detection element 10, in order to improve a fill factor of the sensor section 103 of each pixel 20, it is preferable to increases an area of a light reception region of the sensor section 103. Further, it is preferable to form the sensor section 103 to cover the pixel region. However, when the portion corresponding to the laser beam irradiation portion is covered by the sensor section 103, repairing based on laser cutting cannot be performed. Therefore, it is preferable to configure the sensor section 103 to cover the pixel region provided with the pixel 20 and to expose the portion corresponding to the laser beam irradiation portion.

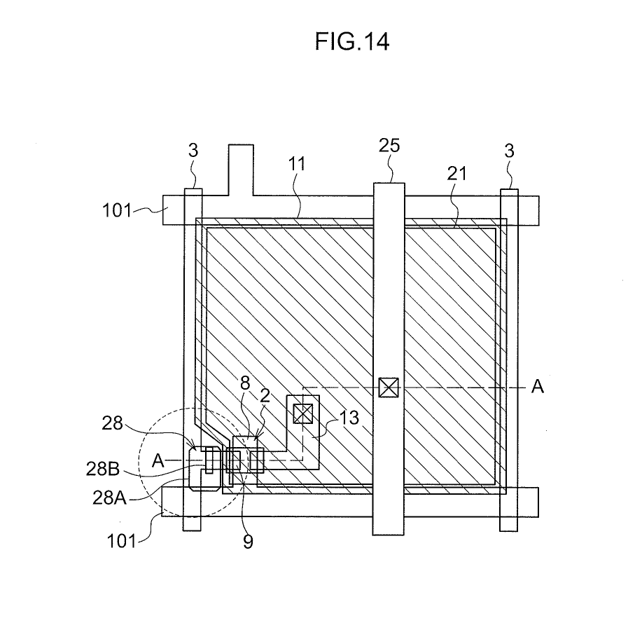

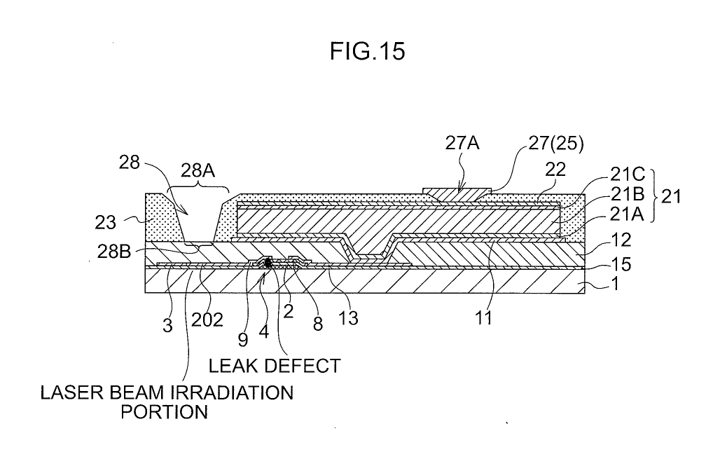

FIG. 14 is a plan view showing a structure of each pixel of a radiation detection element according to an alternative exemplary embodiment in which a sensor section 103 covers a pixel region and a portion corresponding to a laser beam irradiation portion is exposed. FIG. 15 is a cross-sectional view taken along the line A-A of FIG. 14.

In the alternative exemplary embodiment of FIG. 14, the portion corresponding to the laser beam irradiation portion of the sensor section 103 is formed in a concave shape, such that the portion corresponding to the laser beam irradiation portion is exposed. In the intermediate insulation film 23, an opening 28 is formed in the corresponding portion (position) on the laser beam irradiation portion of the line 202. The opening 28 is formed in a tapered shape, such that the width thereof becomes thin as the opening comes close to the intermediate insulation film 12.

Accordingly, in the alternative exemplary embodiment, when the sensor section 103 is formed to cover the pixel region, the fill factor may be improved. In an alternative exemplary embodiment, the portion corresponding to the laser beam irradiation portion is exposed without being covered with the sensor section 103. Therefore, in the alternative exemplary embodiment, when the leak defect is detected, laser repairing where the laser beam is irradiated onto the laser beam irradiation portion, and the lines are changed to a non-conductive state may be easily performed.

The configuration of the radiation imaging device 100 and the configuration of the radiation detection element 10 that are described in the exemplary embodiments are only exemplary. Therefore, various changes may be made in a range within the spirit and scope of the present invention.

For example, the intermediate insulation film 12 may be provided on the lower side of the sensor section 103, and the intermediate insulation film 23 (or 23′) may be provided on the upper side of the sensor section.

What is claimed is:

1. A radiation detection element comprising:
a substrate that has a top surface, which has provided thereon,
a plurality of pixels, disposed in a matrix, that include switching elements for reading out charges generated in sensor sections,
a plurality of scan lines through which control signals flow for switching the switching elements, and
a plurality of signal lines, connected to the switching elements through lines that changes to a non-conductive state by irradiation of a laser beam, wherein electric signals according to the charges generated in the plurality of pixels flow through the plurality of signal lines in accordance with switching states of the switching elements;
a first flattening film provided on a lower side of the sensor sections; and
a second flattening film, provided on an upper side of the sensor sections, wherein portions of the second flattening film that correspond to laser beam irradiation portions of the lines are opened, or a thickness of the portions of the second flattening film that correspond to the laser beam irradiation portions is made thinner than a thickness of portions other than the portions that correspond to the laser beam irradiation portions.

2. The radiation detection element of claim 1, wherein the sensor sections are formed to cover a pixel region where the pixels are disposed, while exposing the portions that correspond to the laser beam irradiation portions.

3. The radiation detection element of claim 2, wherein portions of the sensor sections that correspond to the laser beam irradiation portions are formed in a concave shape.

4. A radiation detection element comprising:
a substrate that has a top surface, which has provided thereon,
a plurality of pixels, disposed in a matrix, that include switching elements for reading out charges generated in sensor sections,
a plurality of scan lines through which control signals flow for switching the switching elements, and
a plurality of signal lines, connected to the switching elements through lines that change to a non-conductive state by irradiation of a laser beam, wherein electric signals according to the charges generated in the plurality of pixels flow through the plurality of signal lines in accordance with switching states of the switching elements;
a first flattening film, provided on a lower side of the sensor sections, wherein a thickness of portions of the first flattening film that correspond to laser beam irradiation portions of the lines is made thinner than a thickness of portions other than the portions that correspond to the laser beam irradiation portions; and
a second flattening film, provided on an upper side of the sensor sections.

5. The radiation detection element of claim 4, wherein portions of the second flattening film that correspond to the laser beam irradiation portions of the lines are opened, or a thickness of the portions of the second flattening film that correspond to the laser beam irradiation portions is made thinner than a thickness of portions other than the portions that correspond to the laser beam irradiation portions.

6. The radiation detection element of claim 4, wherein the sensor sections are formed to cover a pixel region where the pixels are disposed, while exposing the portions that correspond to the laser beam irradiation portions.

7. The radiation detection element of claim 6, wherein portions of the sensor sections that correspond to the laser beam irradiation portions are formed in a concave shape.

8. A radiation detection element comprising:
a substrate that has a top surface, which has provided thereon,
a plurality of pixels, provided in a matrix, that include switching elements for reading out charges generated in sensor sections,
a plurality of scan lines, connected to the switching elements through lines that change to a non-conductive state by irradiation of a laser beam, through which control signals flow for switching the switching elements, and
a plurality of signal lines, through which electric signals according to the charges generated in the plurality of pixels flow, in accordance with switching states of the switching elements;
a first flattening film, provided on a lower side of the sensor sections; and
a second flattening film, provided on an upper side of the sensor sections, wherein portions of the second flattening film that correspond to laser beam irradiation portions of the lines are opened, or a thickness of the portions of the second flattening film that correspond to the laser beam irradiation portions is made thinner than a thickness of portions other than the portions that correspond to the laser beam irradiation portions.

9. The radiation detection element of claim 8, wherein the sensor sections are formed to cover a pixel region where the pixels are disposed, while exposing the portions that correspond to the laser beam irradiation portions.

10. The radiation detection element of claim 9, wherein portions of the sensor sections that correspond to the laser beam irradiation portions are formed in a concave shape.

11. A radiation detection element comprising:
a substrate that has a top surface, which has provided thereon,
a plurality of pixels, disposed in a matrix, that include switching elements for reading out charges generated in sensor sections,
a plurality of scan lines, connected to the switching elements through lines that change to a non-conductive state by irradiation of a laser beam, through which control signals flow for switching the switching elements, and
a plurality of signal lines through which electric signals according to the charges generated in the plurality of pixels flow, in accordance with switching states of the switching elements;
a first flattening film, provided on a lower side of the sensor sections, wherein a thickness of portions of the first flattening film that correspond to laser beam irradiation portions of the lines is made thinner than a thickness of portions other than the portions that correspond to the laser beam irradiation portions; and
a second flattening film, provided on a side opposite to a side of the first flattening film where the substrate is positioned.

12. The radiation detection element of claim 11, wherein portions of the second flattening film that correspond to the laser beam irradiation portions of the lines are opened, or a thickness of the portions of the second flattening film that correspond to the laser beam irradiation portions is made thinner than the thickness of portions other than a portions that correspond to the laser beam irradiation portions.

13. The radiation detection element of claim 11, wherein the sensor sections are formed to cover a pixel region where the pixels are disposed, while exposing the portions that correspond to the laser beam irradiation portions.

14. The radiation detection element of claim 13, wherein portions of the sensor sections that correspond to the laser beam irradiation portions are formed in a concave shape.
